(19) United States
(12) Patent Application Publication
(10) Pub. No.: US 2006/0209171 A1
(43) Pub. Date: Sep. 21, 2006

(54) Optical beam scanning device and image forming apparatus

(75) Inventor: Takashi Shiraishi, Kawasaki-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/079,240

(22) Filed: Mar. 15, 2005

(51) Int. Cl. B41J 27/00

(52) U.S. Cl. 347/259

(57) ABSTRACT

It is an object of the present invention to reduce deterioration of performance due to an attachment error of an optical deflecting device in an optical beam scanning device. The optical beam scanning device of the present invention has a single optical deflecting device, a pre-deflection optical system that allows a light beam from a light source to enter the optical deflecting device, a post-deflection optical system that images a reflected light beam from the optical deflecting device on a surface to be scanned, an optical axis adjusting mechanism that adjusts an optical axis of the pre-deflection optical system, and an optical deflecting device angle adjusting mechanism that adjusts the angle of the optical deflecting device separately from the optical axis adjusting mechanism of the pre-deflection optical system. The optical axis adjusting mechanism is used to adjust the optical axis in the pre-deflection optical system, and the optical deflecting device angle adjusting mechanism is used to adjust the angle of the optical deflecting device.

### BACKGROUND OF THE INVENTION

1. Field of the invention

The present invention relates to an image forming apparatus such as a laser printer or a digital copying machine, and an optical beam scanning device which is capable of applying to the image forming apparatus, in which particularly an adjusting procedure is optimized.

1. Description of the Related Art

Since optical beam scanning devices have a lot of optical parts, after adjustments such as alignment of optical axes are made at the time of assembly, the devices are shipped. Further, at the time of maintenance, adjustments such as the alignment of the optical axes are made suitably.

Conventional methods of adjusting multi-beam optical scanning devices include a method disclosed in Japanese Patent Application Laid-Open No. 4-81809. In this method, a plurality of light sources and optical systems which synthesize individual light beams from the light sources compose subunits, and after optical paths are adjusted by the subunits, angles of the subunits are adjusted around axial centers which intersect with an optical axis of the synthesized beam. In such a manner, scanning ranges can be adjusted collectively.

This conventional method is advantageous to image formation, a beam position in a sub-scanning direction and vignetting due to a polygon mirror from a viewpoint that the optical axis is adjusted in a state that a polygon mirror is not included. An adjustment, however, is not assumed as to an error of the beam optical paths due to an error of installation of the polygon mirror. As a result, this becomes the factor that deteriorates the image formation, the beam position in the sub-scanning direction and the vignetting due to the polygon mirror.

FIGS. 1A, 2A and 3A illustrate main effect plots obtained by simulating a wave aberration (rms opd), the beam position in the sub-scanning direction and an improvement degree of the vignetting due to the polygon mirror according to some conventional adjusting methods when the optical axis which does not include the polygon mirror is adjusted. FIGS. 1B, 2B and 3B are main effect plots obtained by simulating the wave aberration, the beam position in the sub-scanning direction and the improvement degree of the vignetting due to the polygon mirror according to some conventional adjusting methods when the angle of the polygon mirror is adjusted. From FIGS. 1A to 3B, the wave aberration and the vignetting due to the polygon mirror are improved to approximately equivalent degree in both the cases, but the beam position in the sub-scanning direction is improved more effectively when the angle of the polygon mirror is adjusted than the other case.

A fluctuation in the beam position in the sub-scanning direction is a very important performance in color multi-beam optical scanning devices where adjacent beams are separated by a return mirror in a post-deflection optical system.

A method of the main effect plot which is used a lot in this specification is explained below.

For example, if items and conditions in two states which are considered to influence property values are A, B, C, . . . , Z, an average or a least squares average of property values in all combinations of B, C, . . . , Z relating to the first state of A (“0” in FIGS. 1 to 3) is plotted, and an average or a least squares average of the property values in all combinations of B, C, . . . , Z relating to the second state of A (“1” in FIGS. 1 to 3) is plotted. When there is no difference between the plotted value in the first state of A and the plotted value in the second state of A, A is not much related to nor contribute to the property value, and when there is a great difference between the plotted value in the first state of A and the second state of A, A greatly influences or contributes to the property value. Broken lines in FIGS. 1A to 3B represent the average or the least squares average of the property values in all the cases.

### SUMMARY OF THE INVENTION

It is an object of an aspect of the present invention to provide an optical beam scanning device which is capable of reducing deterioration of a performance due to an installation error of an optical deflecting device, an image forming apparatus using such an optical beam scanning device, and a method of adjusting the optical beam scanning device.

An optical beam scanning device according to a first aspect of the present invention includes: a single optical deflecting device; a pre-deflection optical system that allows a light beam from a light source to enter the optical deflecting device; a post-deflection optical system that images a reflected light beam from the optical deflecting device on a surface to be scanned; an optical axis adjusting mechanism that adjusts an optical axis of the pre-deflection optical system; and an optical deflecting device angle adjusting mechanism that adjusts the angle of the optical deflecting device separately from the optical axis adjusting mechanism of the pre-deflection optical system.

An optical beam scanning device adjusting method according to a second aspect of the present invention is constituted so that the optical axis adjusting mechanism of the optical beam scanning device according to the first invention is used to adjust the optical axis in the pre-deflection optical system, and the optical deflecting device angle adjusting mechanism is used to adjust the angle of the optical deflecting device.

An image forming apparatus according to a third aspect of the present invention includes the optical beam scanning device according to the first aspect of the present invention and a photoconductor that has a surface to be scanned on which a latent image is formed based on the light beam from the optical beam scanning device.

### BRIEF DESCRIPTION OF THE DRAWINGS

FIGS. 1A and 1B are main effect plot charts illustrating an improvement degree of wave aberration (rms opd) when an optical axis excluding a polygon mirror is adjusted and wave aberration when an angle of the polygon mirror is adjusted;

FIGS. 2A and 2B are main effect plot charts illustrating an improvement degree of a beam position in a sub-scanning direction when the optical axis excluding the polygon mirror is adjusted and a beam position in the sub-scanning direction when the angle of the polygon mirror is adjusted;

FIGS. 3A and 3B are main effect plot charts illustrating an improvement degree of vignetting due to the polygon mirror when the optical axis excluding the polygon mirror is adjusted and vignetting due to the polygon mirror when the angle of the polygon mirror is adjusted;

FIG. 4 is a schematic plan view illustrating an arrangement of optical members in an optical beam scanning device which is assumed at the time of examining adjustment items;

FIG. 5 is an explanatory diagram illustrating an advancing direction of laser beams in an optical element relating to synthesizing of optical paths in a pre-deflection optical system in FIG. 4;

FIG. 6 is a schematic vertical sectional view illustrating the optical beam scanning device of FIG. 4;

FIG. 7 is an explanatory diagram illustrating assumed adjustment places and adjustment items (simulation conditions);

FIG. 8 is a main effect plot chart illustrating the wave aberration (rms opd) of simulated results;

FIG. 9 is a main effect plot chart illustrating the wave aberration (rms opd) of the simulated results excluding a condition 10 of FIG. 7;

FIG. 10 is a main effect plot chart illustrating a beam gap error in the sub-scanning direction in a position where a light beam in a post-deflection optical system is separated in the simulated results excluding the condition 10 of FIG. 7;

FIG. 11 is a main effect plot chart illustrating a change in a light amount due to the vignetting caused by a reflecting surface of the polygon mirror in the simulated results excluding the condition 10 of FIG. 7;

FIG. 12 is an explanatory diagram illustrating an evaluation list of the assumed adjustment places and adjustment items;

FIG. 13 is a schematic vertical sectional view illustrating a constitution of an image forming apparatus to which the optical beam scanning device according to a first embodiment is applied;

FIGS. 14A and 14B are a schematic plan view and a schematic vertical sectional view illustrating a constitution of the optical beam scanning device according to the first embodiment;

FIGS. 15A and 15B area schematic plan view and a schematic vertical sectional view illustrating the constitution of the optical beam scanning device according to a second embodiment;

FIGS. 16A and 16B are a schematic plan view and a schematic vertical sectional view illustrating the constitution of the optical beam scanning device according to a third embodiment; and

FIGS. 17A and 17B area schematic plan view and a schematic vertical sectional view illustrating the constitution of the optical beam scanning device according to a fourth embodiment;

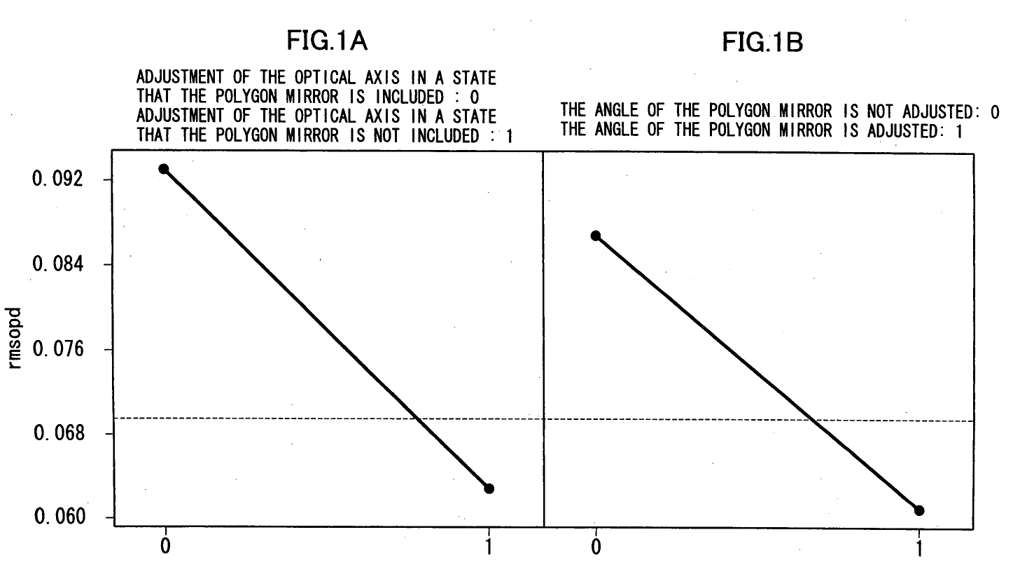

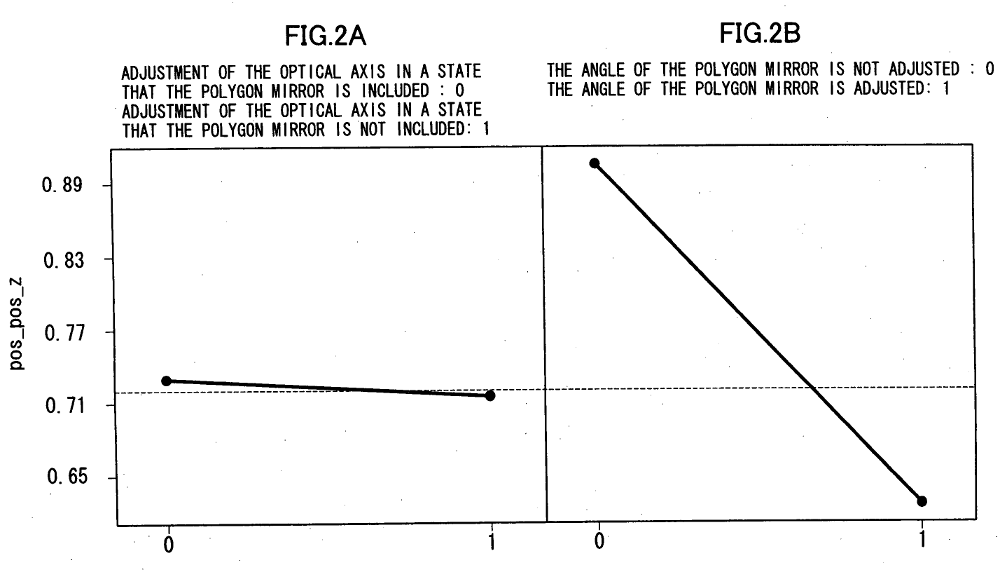

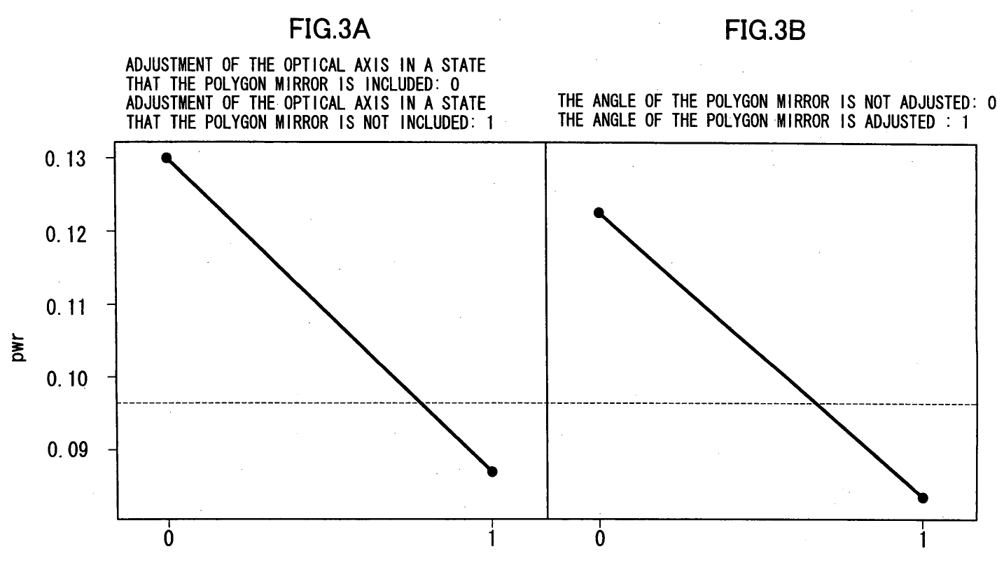

### DESCRIPTION OF THE EMBODIMENTS

### (A) Consideration of Adjustment Items and Adjusting Method in Embodiments

Before an optical beam scanning device, an image forming apparatus and a method of adjusting the optical beam scanning device according to the embodiments of the present invention are explained, contents which are considered in order to attain the embodiments are explained. The considered contents include adjustment items such as wave aberration (rms opd), a beam position in a sub-scanning direction and vignetting due to a polygon mirror which influence optical properties.

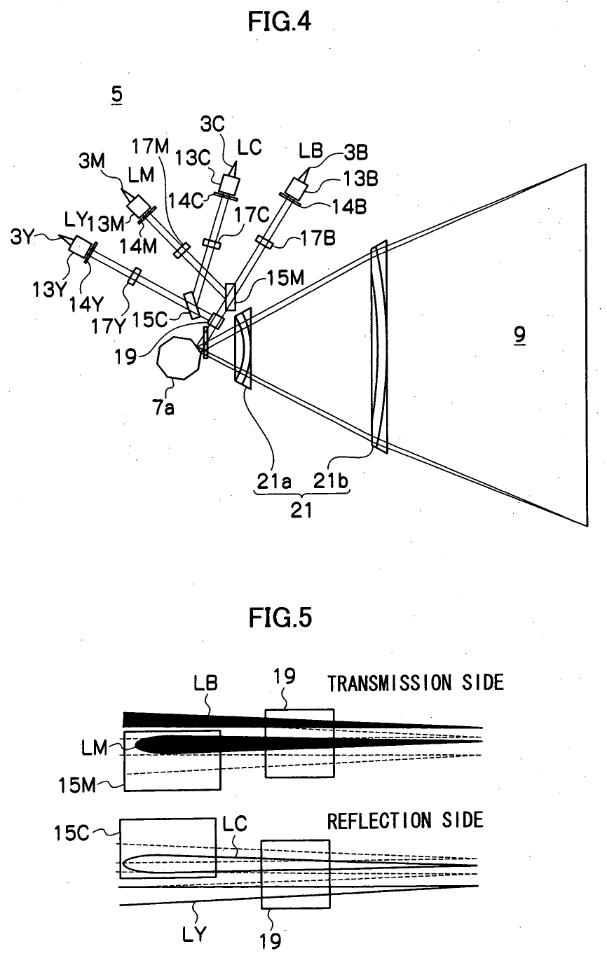

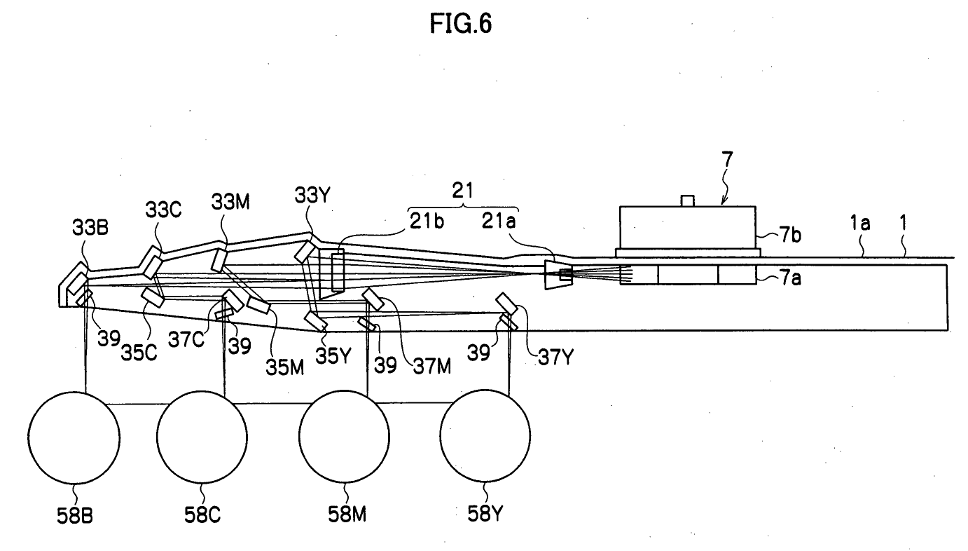

FIGS. 4 to 6 are explanatory diagrams illustrating the optical beam scanning device which is assumed at the time of consideration. FIG. 4 is a schematic plan view illustrating an arrangement of optical members in the optical beam scanning device assumed at the time of the consideration of the adjustment items, and return by means of return mirrors is developed in a post-deflection optical system. FIG. 5 is an explanatory diagram illustrating an advancing direction of laser beams in an optical element relating to synthesization of optical paths in a pre-deflection optical system of FIG. 4. FIG. 6 is a schematic vertical sectional view of the optical beam scanning device in FIG. 4, and mainly illustrates that the post-deflection optical system forms a unit.

The optical beam scanning device which is applied to a color image forming apparatus normally utilizes four sets of various parts for forming images according to respective color components including Y (yellow), M (magenta), C (cyan) and B (black). For this reason, Y, M, C and B are added to reference numerals so that the parts according to the color components can be identified.

The assumed optical beam scanning device 1 has light sources (laser diodes) 3Y, 3M, 3C and 3B that output light beams to first to fourth image forming sections, not shown, respectively, and one optical deflecting device 7 as a deflecting unit that deflects (scans) the light beams (laser beams) emitted from the light sources 3 (Y, M, C and B) towards image surfaces arranged in predetermined positions, namely, outer peripheral surfaces of photoconductor drums 58Y, 58M, 58C and 58B in the first to the fourth image forming sections shown in FIG. 6 at a predetermined linear speed. Pre-deflection optical systems 5 (Y, M, C and B) are arranged between the optical deflecting device 7 and the light sources 3 (Y, M, C and B), and a post-deflection optical system 9 is arranged between the optical deflecting device 7 and the image surfaces.

As shown in FIG. 4, the pre-deflection optical systems 5 includes the light sources 3 (Y, M, C and B) composed of semiconductor laser elements for the respective color components, finite focal lenses 13 (Y, M, C and B) that provide predetermined convergence to the laser beams emitted from the light sources 3 (Y, M, C and B), diaphragms 14 (Y, M, C and B) that give arbitrary sectional beam shapes to the laser beams L which pass through the finite focal lenses 13 (Y, M, C and B), and cylinder lenses 17 (Y, M, C and B) that further provide predetermined convergence to the laser beams which pass through the diaphragms 14 (Y, M, C and B) in a sub-scanning direction. The pre-deflection optical systems 5 adjust the sectional beam shapes of the laser beams emitted from the light sources 3 (Y, M, C and B) into predetermined shapes so as to guide them to a reflecting surface of the optical deflecting device 7.

The yellow laser beam LY emitted from the cylinder lens 17Y passes below a return mirror 15C, and is reflected by a polarization beam splitter (it may be a half mirror prism or a half mirror) 19 so as to be guided to the reflecting surface of the optical deflecting device 7. After an optical path of the magenta laser beam LM emitted from the cylinder lens 17M is returned by a return mirror 15M, the magnet laser beam LM straightly advances along the polarization beam splitter 19 so as to be guided to the reflecting surface of the optical deflecting device 7. After an optical path of the cyan laser beam LC emitted from the cylinder lens 17C is returned by a return mirror 15C, the cyan laser beam LC is reflected by the polarization beam splitter 19 so as to be guided to the reflecting surface of the optical deflecting device 7. The black laser beam LB emitted from the cylinder lens 17B passes above the return mirror 15M, and is reflected by the polarization beam splitter 19 so as to be guided to a reflection deflecting surface of the optical deflecting device 7.

The optical deflecting device 7 has a polygon mirror main body (polygon mirror) 7a in which eight flat reflecting surfaces (flat mirror) are arranged into a regular polygon shape, for example, and a motor 7b that rotates the polygon mirror main body 7a to a main scanning direction at a predetermined speed.

The post-deflection optical system 9 has a pair of image forming lenses (fθ lenses) 21 (21a and 21b) that optimize shapes and positions of the laser beams L (Y, M, C and B) deflected (scanned) by the polygon mirror main body 7a on the image surfaces, a plurality of mirrors 33Y, 35Y, 37Y, 33M, 35M, 37M, 33C, 35C, 37C and 33B and the like that guide the laser beams L (Y, M, C and B) according to the color components emitted from the paired image forming lenses 21 to the corresponding photoconductor drums 58 (Y, M, C and B). The mirrors 33Y, 33M and 33C are optical path separating mirrors that separate the optical paths of the laser beams L (Y, M, C and B) for the respective color components.

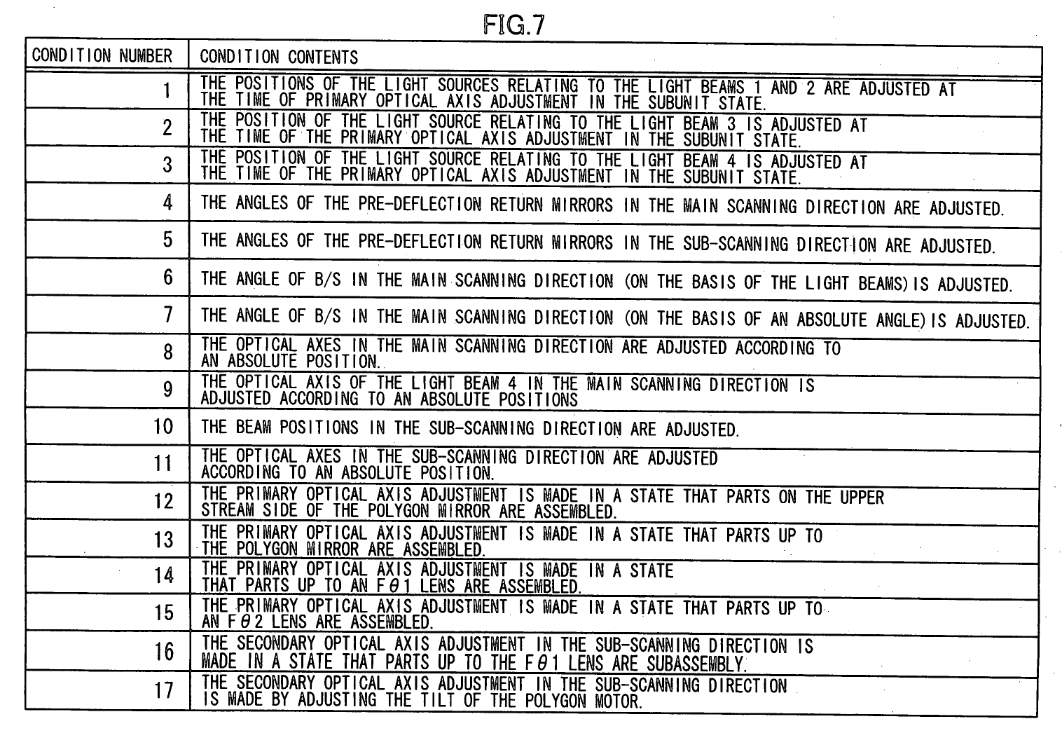

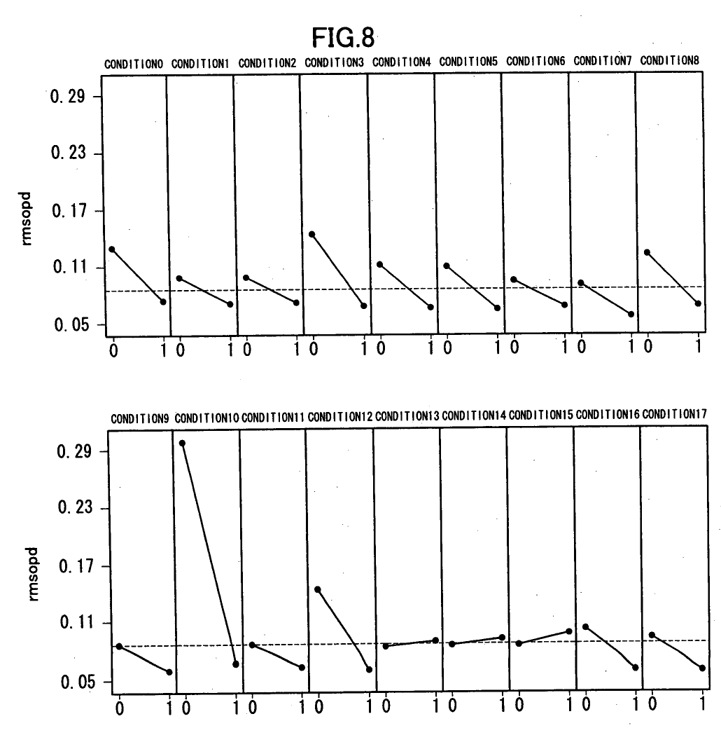

FIG. 7 is an explanatory diagram of assumed adjustment places and adjustment items (simulation conditions). The laser beams LC, LM, LY and LB are represented by light beams 1, 2, 3 and 4. “Primary” represents the adjustment places and adjustment items at the time of assembly of the pre-deflection optical systems 5, and “secondary” represents the adjustment place and the adjustment items after the pre-deflection optical systems 5 are assembled. Further, “subunit” represents that the pre-deflection optical systems 5 form subunits.

Condition (adjustment place and adjustment item) 1: positions of the light sources (laser diodes) 3C and 3M relating to the light beams 1 and 2 are adjusted at the time of primary optical axis adjustment in the subunit state.

Condition 2: a position of the light source (laser diode) 3Y relating to the light beam 3 is adjusted at the time of the primary optical axis adjustment in the subunit state.

Condition 3: a position of the light source (laser diode) 3B relating to the light beam 4 is adjusted at the time of the primary optical axis adjustment in the subunit state.

Condition 4: angles of the return mirrors 15C and 15M of the pre-deflection optical systems in the main scanning direction are adjusted.

Condition 5: angles of the return mirrors 15C and 15M of the pre-deflection optical systems in the sub-scanning direction are adjusted.

Condition 6: an angle of the polarization beam splitter 19 in the main scanning direction (on the basis of the light beams) is adjusted.

Condition 7: the angle of the polarization beam splitter 19 in the main scanning direction (on the basis of an absolute angle) is adjusted.

Condition 8: the optical axes of the light beams 1 to 3 in the main scanning direction are adjusted according to an absolute position.

Condition 9: the optical axis of the light beam 4 in the main scanning direction is adjusted according to an absolute position.

Condition 10: the beam positions in the sub-scanning direction are adjusted.

Condition 11: the optical axes in the sub-scanning direction are adjusted according to an absolute position.

Condition 12: the primary optical axis adjustment is made in a state that parts on the upper stream side of the polygon mirror 7a are assembled.

Condition 13: the primary optical axis adjustment is made in a state that parts up to the polygon mirror 7a are assembled.

Condition 14: the primary optical axis adjustment is made in a state that parts up to a first fθ lens 21a are assembled.

Condition 15: the primary optical axis adjustment is made in a state that parts up to the second fθ lens 21b are assembled.

Condition 16: a secondary optical axis adjustment in the sub-scanning direction is made in a state that parts up to the first fθ lens 21a are subassembly.

Condition 17: the secondary optical axis adjustment in the sub-scanning direction is made by adjusting the angle of the polygon motor 7b.

When predetermined errors are given to the parts and their arrangement and the adjustment places in FIG. 7 are adjusted, wave aberration (rms opd), a beam gap pitch in the sub-scanning direction in the light beam separated position of the post-deflection optical system, and the vignetting due to the polygon mirror are simulated based on a tolerance analyzing method.

The results are considered according to main effect plots. In the main effect plot charts, mentioned later, the conditions which are considered are shown on the plot, “0” below the plot shows that the adjustment relating to that condition is not made, and “1” below the plot shows that the adjustment relating to the condition is made.

FIG. 8 is a main effect plot chart of the wave aberration (rms opd). From FIG. 8, it is found that an effect which is produced by the adjustment under the condition 10 (namely, the optical axis in the sub-scanning direction is adjusted) other than adjustment of the optical axis elements including the light sources and the finite focal lenses is great. For this reason, hereinafter, the consideration proceeds on the assumption that the condition 10 is applied.

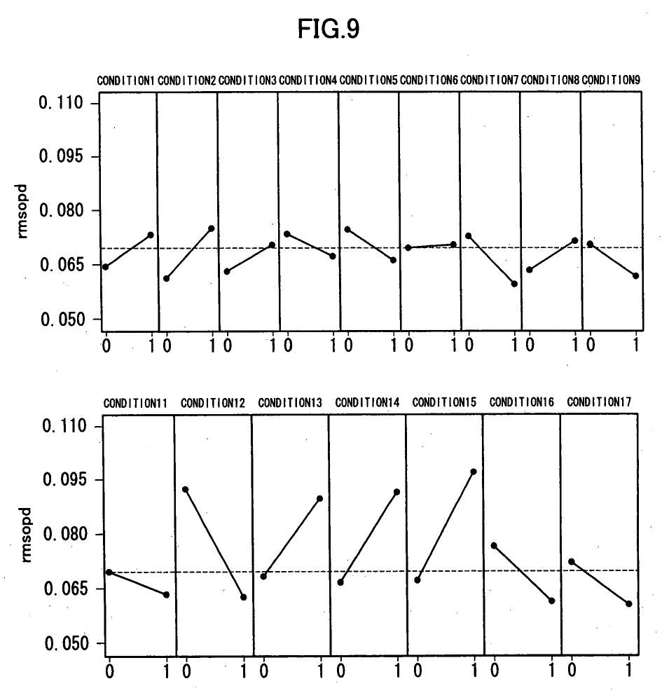

A main effect plot chart on the assumption that the adjustment under the condition 10 is made is shown in FIG. 9. From FIG. 9, the following is found.

1-1: in the optical axis adjustment under the conditions 12 to 15, when the optical axis is adjusted without including the polygon mirror under the condition 12, the wave aberration becomes small (when the optical axis is adjusted with the polygon mirror being included, the wave aberration is deteriorated as shown in the conditions 13 to 15).

1-2: in the optical axis adjusting method in the condition 12, since a shift of the optical axis due to parts accuracy and arrangement accuracy of the polygon mirror and the post-deflection optical system cannot be corrected, it is desirable that the optical axis is adjusted in any manner after the above adjustment from the viewpoint that the optical axis is matched with a design value. From the plot of conditions 16 and 17 in FIG. 9, it is found that when the angle of the subunit including up to the polygon mirror or the first fθ lens is adjusted and the optical axis is aligned, the image forming properties are also improved.

1-3: From the plot of conditions 6 and 7, when the angle of the polarization beam splitter is adjusted according to an absolute angle, the wave aberration is improved.

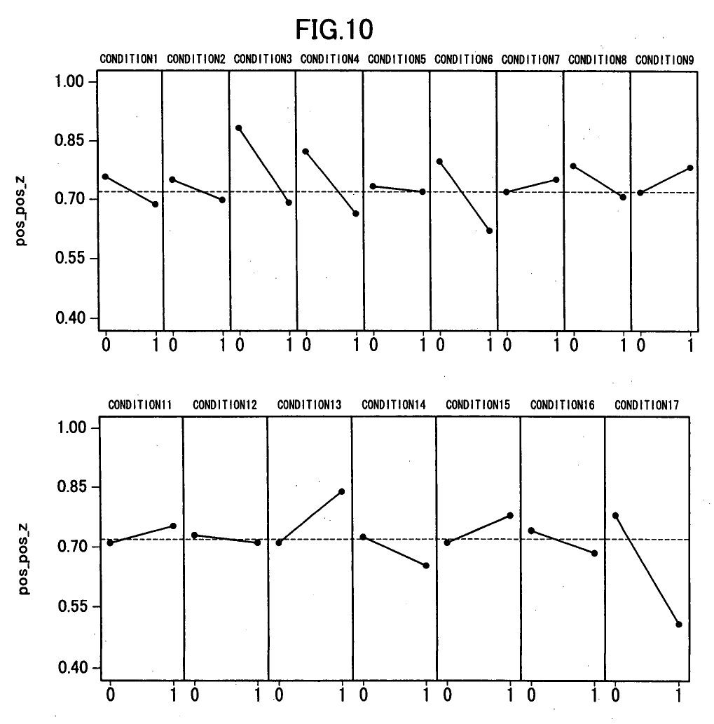

As to the error of the beam gaps in the sub-scanning direction in the position where the light beams are separated in the post-deflection optical system, the adjustment places and the like are considered with reference to the main effect plot chart in FIG. 10. From FIG. 10, the following is found.

2-1: from the conditions 2 and 3, it is desirable that the positions of the light sources for the light beams which are not reflected by the return mirrors and the polarization beam splitter are adjusted.

2-2: from the condition 6, it is effective that the rotation of the polarization beam splitter about the optical axis is adjusted based on the light beams (while the beam positions on the lower stream side of the light beams are being viewed, the rotation of the polarization beam splitter is adjusted).

2-3: from the plot of condition 17, it is greatly effective that the angle of the polygon mirror is adjusted (from the plot of condition 16, it is effective to a certain extent that the angle of the subunit up to the first fθ lens is adjusted).

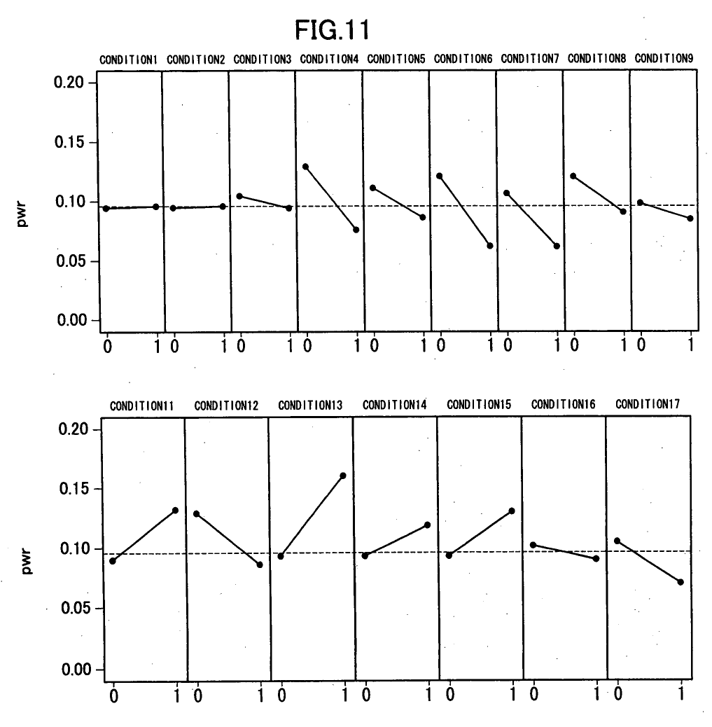

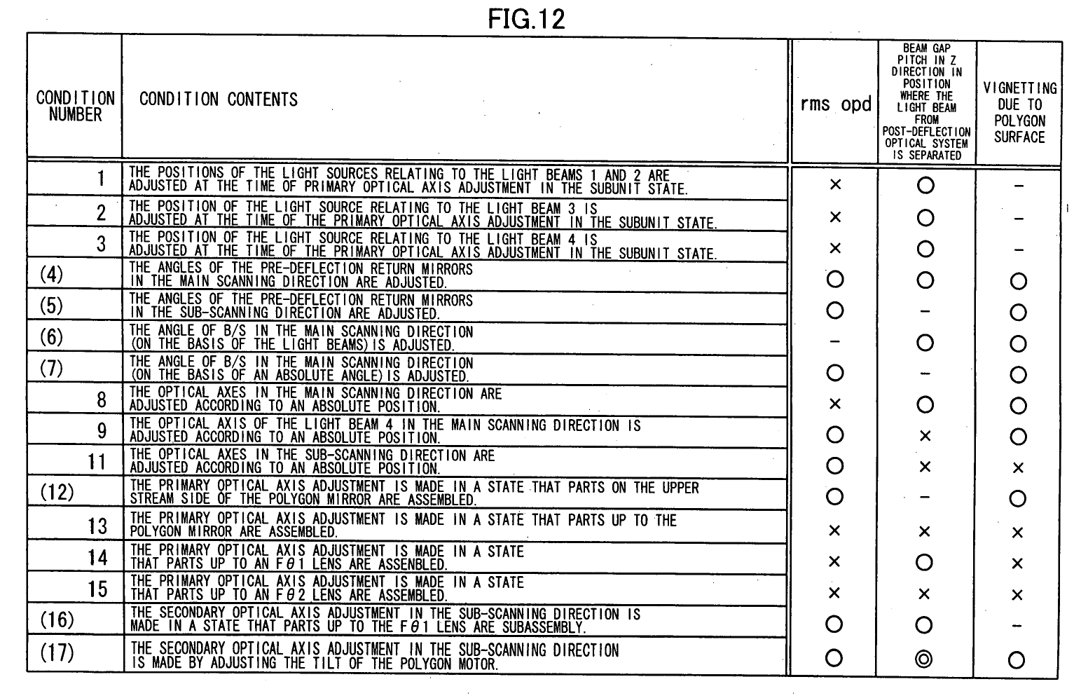

FIG. 11 is a main effect plot chart of a fluctuation in a light amount due to the vignetting caused by the edge portion of the polygon mirror which represents a change in the light amount on the image surfaces when the polygon mirror of minimum size is used and the vignetting due to the polygon mirror is considered. Explanation about considered results of the fluctuation in the light amount due to the vignetting caused by the edge portion of the polygon mirror under the conditions are omitted, but FIG. 12, mentioned later, includes these considered results from this aspect.

FIG. 12 shows the considered results which are simplified. In FIG. 12, as to properties of the wave aberration, the beam gap pitch in the sub-scanning direction in the light beam separated position of the post-deflection optical system and the vignetting due to the reflecting surface of the polygon mirror, advantageous condition is designated by “◯”, disadvantageous condition is designated by “×”, and a condition which has no influence is designated by “−”. A condition number of the adjustment items (conditions) in FIG. 12 which is advantageous to any properties and is disadvantageous to no property is designated by 0.

That is, the adjustment items (conditions) which are advantageous to any one of the properties and are disadvantageous to no properties include (4) an angle of a pre-deflection return mirror in the main scanning direction is adjusted, (5) an angle of the pre-deflection return mirror in the sub-scanning direction is adjusted, (6) the angle of the polarization beam splitter in the main scanning direction (based on the light beams) is adjusted, (7) the angle of the polarization beam splitter in the main scanning direction (the absolute angle is aligned) is adjusted, (12) the primary optical axis adjustment in the state that the parts on the upper stream side of the polygon mirror are assembled, (16) the secondary optical axis adjustment in the sub-scanning direction in the state that the parts up to the first fθ lens are subassembly, and (17) the secondary optical axis adjustment in the sub-scanning direction by adjusting the tilt of the polygon motor.

In order to improve the performance of the optical beam scanning device, it is desirable that these items are combined and the adjustment is made. The adjusting method where these items are combined includes the following four kinds of adjusting methods, for example. The step processes in the following adjusting methods may be executed in a reversed order or simultaneously when the order with respect to the other step processes does not become a problem.

### First Adjusting Method (Adjusting Method in First Embodiment)

step 1; the optical parts on the upper stream side of the polygon mirror on the optical path are assembled on the subunit, and the positions of the light sources are adjusted so that the optical axes are adjusted.

step 2; the angle of the polarization beam splitter in the main scanning direction is adjusted while the beams are being projected onto the reflecting surface of the polarization beam splitter and the position and the angle of the reflected light is being viewed, or the beam positions adjusted at the step 1 are measured in a predetermined position so as to be adjusted.

step 3; the subunit is mounted on the entire optical unit, the polygon mirror (polygon motor) and the fθ lens are mounted, and while their positions in the sub-scanning direction are viewed in a predetermined position, the angle of the polygon mirror in the sub-scanning direction is adjusted.

“To mount” in this specification means not only “to place on a certain surface” but widely means “to wear”.

### Second Adjusting Method (Adjusting Method in Second Embodiment)

step 1; the optical parts on the upper streams side of the polygon mirror on the optical path are assembled on the unit, and the positions of the light sources are adjusted so that the optical axis adjustment is made. At this time, the polygon mirror is not mounted, a hole is provided on a wall surface of the unit in order to view the optical path, and a plate is stuck to cover the hole portion after the adjustment. The hole is not limited to a mechanical hole and may be an optical hole.

step 2; a beam is projected to the reflecting surface of B/S, and the angle of B/S in the main scanning direction is adjusted while the position or the angle of the reflected light is being viewed, or the position of the beam adjusted at step 1 is measured in a predetermined position so that the adjustment is made.

step 3; the polygon mirror (polygon motor) and the fθ lens is mounted on the optical unit, and while the position in the sub-scanning direction is viewed in a predetermined position, the angle of the polygon mirror in the sub-scanning direction is adjusted.

### Third Adjusting Method (Adjusting Method in Third Embodiment)

step 1; the optical parts on the upper stream side of the polygon mirror on the optical path are assembled on the subunit, and the positions of the light sources are adjusted so that the optical axes are adjusted. This subunit is constituted so that the polygon motor is mounted, but at this time, the polygon motor is not yet mounted.

step 2; beams are projected onto the reflecting surface of the polarization beam splitter, and the angle of the polarization beam splitter in the main scanning direction is adjusted while the positions or the angles of the reflected light beams are being viewed, or the beam positions adjusted at step 1 are measured in a predetermined position so that the adjustment is made.

step 3; the polygon mirror (polygon motor) is mounted onto the subunit, the subunit is mounted onto the entire optical unit, and the fθ lens is mounted onto the entire optical unit, so that the angle of the subunit is adjusted while the position in the sub-scanning direction is being viewed in a predetermined position.

### Fourth Adjusting Method (Adjusting Method in Fourth Embodiment)

step 1; the optical parts on the upper stream side of the polygon mirror on the optical path and the first fθ lens (the lens close to the polygon mirror) are assembled on the subunit, and the positions of the light sources are adjusted so that the optical axes are adjusted. The subunit is constituted so that the polygon motor and the first fθ lens are mounted, but at this time, the polygon motor is not yet mounted.

step 2; the beams are projected to the reflecting surface of the polarization beam splitter, and while the positions and the angles of the reflected light beams are being viewed, the angle of the polarization beam splitter in the main scanning direction is adjusted, or the beam positions adjusted at step 1 are measured in a predetermined position so that the adjustment is made.

step 3; the polygon mirror (polygon motor) is mounted on the subunit, the subunit is mounted on the entire optical unit, another fθ lens (second fθ lens) is mounted on the entire optical unit. While the position in the sub-scanning direction is being viewed in a predetermined position, the angle of the subunit is adjusted.

In the four adjusting methods, in the case of the optical axis adjustment of the optical parts on the upper stream side of the polygon mirror on the optical path, when the return mirror is adjusted on the optical path in the pre-deflection optical system including the return mirror, the image forming properties are improved. As a result, variation of the sub-scanning beam positions in the light beam separating position of the post-deflection optical system and fluctuation in vignetting due to the polygon mirror can be suppressed.

In the third and the fourth methods, like the second adjusting method, the subunit is placed on the unit in advance, the polygon mirror is not placed so as to adjust the optical axis, and a hole is pierced in the wall surface of the unit in order to view the optical path so that the subunit can be adjusted.

The steps 2 in the respective methods can be omitted according to necessary accuracy.

In the above explanation, the multi-color optical system is considered, but it goes without saying that optical systems for single beam can produce the same effect. That is, in the optical systems for single beam, the beam gap pitch in the sub-scanning direction in the light beam separating position of the post-deflection optical system in FIG. 12 is not the evaluation characteristics, but also when the two characteristics of the wave aberration and the change in the light amount caused by the vignetting due to the reflecting surface of the polygon mirror are considered, the important adjustment items are the same as those in the case of the multi-beam, and the similar adjusting methods can be applied.

### (B) First Embodiment

The optical beam scanning device, the image forming apparatus and the method of adjusting the optical beam scanning device according to a first embodiment of the present invention are explained below.

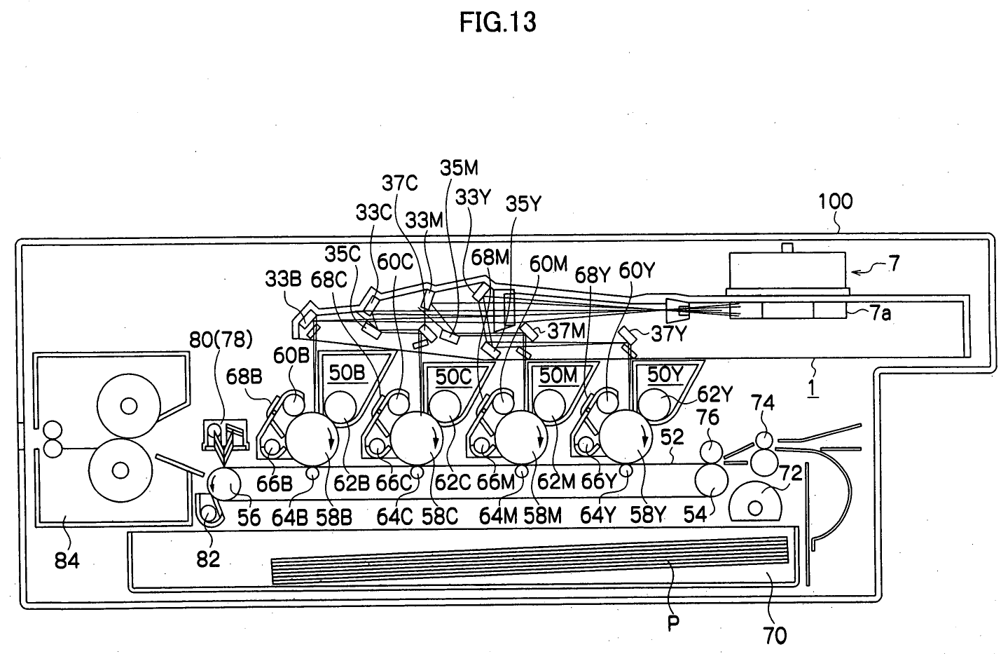

FIG. 13 illustrates the color image forming apparatus using the optical beam scanning device according to the first embodiment. FIG. 13 is a schematic vertical sectional view of the color image forming apparatus according to the first embodiment.

As shown in FIG. 13, the image forming apparatus 300 has first to fourth image forming sections 50Y, 50M, 50C and 50B that form images according to separated color components.

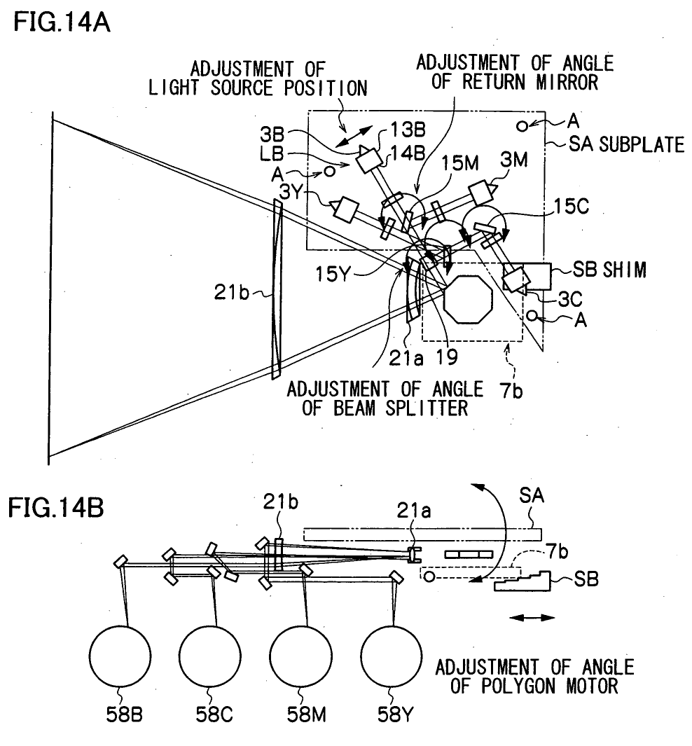

The image forming sections 50 (Y, M, C and B) are arranged in this order in corresponding positions below the optical beam scanning device 1 where laser beams L (Y, M, C and B) for optically scanning image information for the respective color components are emitted by a first return mirror 33B and third return mirrors 37Y, 37M and 37C of the multi-beam optical scanning device 1 to be explained with reference to FIGS. 14A and 14B.

A transport belt 52 that transports transfer materials onto which the images formed via the image forming sections 50 (Y, M, C and B) are transferred is arranged below the image forming sections 50 (Y, M, C and B).

The transport belt 52 is bridged between a belt driving roller 56 which is rotated to a direction of an arrow by a motor, not shown, and a tension roller 54 and it is rotated to a direction where the belt driving roller 56 rotates at a predetermined speed.

The image forming sections 50 (Y, M, C and B) are formed into a cylindrical shape so as to be capable of rotating to the direction of an arrow, and have photoconductor drums 58Y, 58M, 58C and 58B on which electrostatic latent images according to images exposed by the optical beam scanning device are formed.

Charging devices 60 (Y, M, C and B) that provide a predetermined electric potential to the surfaces of the photoconductor drums 58 (Y, M, C and B), developing devices 62 (Y, M, C and B) that supply toner with colors corresponding to the electrostatic latent images formed on the surfaces of the photoconductor drums 58 (Y, M, C and B) to develop them, transfer devices 64 (Y, M, C and B) that are opposed to the photoconductor drums 58 (Y, M, C and B) at the rear surface of the transport belt 52 in a state that the transport belt 52 intervenes between the photoconductor drum 58 (Y, M, C and B) and the transfer devices 64 (Y, M, C and B) and transfer the toner images on the photoconductor drums 58 (Y, M, C and B) onto a recording medium, namely, recording paper P transported by the transport belt 52, cleaners 66 (Y, M, C and B) that remove residual toner on the photoconductor drums 58 (Y, M, C and B) which is not transferred onto the paper P by the transfer devices 64 (Y, M, C and B), and discharging devices 68 (Y, M, C and B) that eliminate residual potential on the photoconductor drums 58 (Y, M, C and B) after the toner images are transferred by the transfer devices 64 (Y, M, C and B) are arranged around the photoconductor drums 58 (Y, M, C and B) in this order along a direction where the photoconductor drums 58 (Y, M, C and B) rotate.

A paper cassette 70 that houses the recording paper P to which the images formed by the image forming sections 50 (Y, M, C and B) are transferred is arranged below the transport belt 52.

A delivery roller 72, which is formed into an approximately semilunar shape and takes out the paper P housed in the paper cassette 70 one by one from the top, is arranged at one end of the paper cassette 70 on a side adjacent to the tension roller 54.

A registration roller 74, which aligns a forward end of one piece of paper P taken out of the cassette 70 with a forward end of the toner image formed on the photoconductor drum 58B of the image forming section 50B (black), is arranged between the delivery roller 72 and the tension roller 54.

An absorption roller 76, which provides a predetermined electrostatic absorption power to one piece of paper P transported by the registration roller 74 at predetermined timing, is arranged in a position opposed to an outer periphery of the transport belt 52 corresponding to a position where the tension roller 54 substantially contacts with the transport belt 52 in a vicinity of the tension roller 54 between the registration roller 74 and the first image forming section 50Y.

Registration sensors 78 and 80, which detect the position of the image formed on the transport belt 52 or the image transferred onto the paper P, are arranged on the outer periphery of the transport belt 52 which substantially comes in contact with the belt driving roller 56 at one end of the transport belt 52 and in the vicinity of the belt driving roller 56 at a predetermined distance in an axial direction of the belt driving roller 56 (since FIG. 13 is the vertical sectional view, the first sensor 78 positioned on the front side of the paper cannot be seen in FIG. 13).

A transport belt cleaner 82, which removes the toner and paper dust of the paper P adhering to the transport belt 52, is arranged in a position which does not come in contact with the paper P transported by the transport belt 52 on the outer periphery of the transport belt 52 in contact with the belt driving roller 56.

A fixing device 84, which fixes the toner image transferred onto the paper P to the paper P, is arranged in a direction where the paper P transported via the transport belt 52 is separated from the belt driving roller 56 and is further transported.

FIGS. 14A and 14B are a schematic plan view and a schematic sectional view illustrating the multi-beam optical scanning device 1 according to the first embodiment to be incorporated into the image forming apparatus shown in FIG. 13. In FIG. 14A, as to the post-deflection optical system, a return by means of its return mirror is developed. In FIGS. 14A and 14B, portions which are the same as and correspond to those in FIGS. 4 to 6 showing the optical beam scanning device which is assumed based on the consideration of the adjustment items are designated by the same and corresponding reference numerals, but some reference numerals are omitted from the viewpoint of the area of the paper. FIGS. 14A and 14B clearly illustrate the constitution which can realize the first adjusting method.

The optical beam scanning device 1 according to the first embodiment is provided with a return mirror 15Y which returns the yellow laser beam LY emitted from the cylinder lens 17 Y as a component of the optical system. This point is different from the assumed optical beam scanning device, but the other parts are similar.

In the optical beam scanning device 1 according to the first embodiment, the light sources and all the components of the pre-deflection optical systems are mounted on a subplate SA, and are attached to the unit of the optical beam scanning device 1 via the subplate SA (in the drawing, represented by an alternate long and short dash line). That is, the subplate SA is mounted with the light sources 3 (Y, M, C and B), the finite focal lenses 13 (Y, M, C and B), the diaphragms 14 (Y, M, C and B), the cylinder lenses 17 (Y, M, C and B), the return mirrors 15Y, 15M and 15C, and the polarization beam splitter 19.

The return mirrors 15Y, 15M and 15C are provided onto the subplate SA so that their angles in the main scanning direction (the direction of an arrow in FIG. 14A) and their angles in the sub-scanning direction can be adjusted. For example, the three return mirrors are retained to the adjusting mechanism in such a manner that one is fixed and two are attached by set screws so as to be capable of advancing and retreating, and the adjusting mechanism is retained to the opposite side to the surface to which the return mirrors are retained by a plate spring via the return mirrors.

The polarization beam splitter 19 is also provided to the subplate SA so that at least its angle in the main scanning direction (the direction of an arrow in FIG. 14A) can be adjusted. This adjusting mechanism is similar to the adjusting mechanism of the return mirrors, for example.

The light sources 3 (Y, M, C and B) are provided to the subplate SA by a mechanism which can move to the direction of the arrow in FIG. 14A (main scanning direction) and a direction vertical to the paper surface of FIG. 14A.

The optical deflecting device 7 (polygon motor 7b) is attached to the unit of the optical beam scanning device 1 so that the angle in the sub-scanning direction can be adjusted. This adjusting mechanism is composed of a step-shaped shim SB which is provided between the polygon motor 7a and the unit and can adjust the position to a direction of an arrow in FIG. 14B, and screws which tighten the shim SB.

An A portion in FIG. 14A is a place where the subplate SA is fixed to the unit via an elastic wave washer or the like by a screw.

The adjusting method according to the first embodiment is according to the first adjusting method.

The position of the light source 3B for the black laser beam LB is adjusted in a state that the optical deflection device 7 is detached in order to adjust the optical path, and as to the laser beams LY, LM and LC for the other colors, the light sources 3Y, 3M and 3C are moved so that their positions are adjusted for sets of the light sources 3Y, 3M and 3C and the finite lenses 13Y, 13M and 13C. Thereafter, the polarization beam splitter 19 and the return mirrors 15Y, 15M and 15C on the optical path before deflection are adjusted. In order to secure higher accuracy, after the angles of the polarization beam splitter 19 and the return mirrors 15Y, 15M and 15C are adjusted by using light beams dedicated to adjustment, the positions of the light sources 3Y, 3M and 3C for the colors other than black are adjusted.

As to the adjustment here, for example, the angle of the polarization beam splitter 19 is firstly adjusted, the angles of the return mirrors 15Y, 15M and 15C are secondary adjusted, and the positions of the light sources 3Y, 3M, 3C and 3B are thirdly adjusted. In the first and the second adjustments, for example, standard light sources are used, and in the third adjustment, the light sources as actual products may be mounted. Further, when the positions of the light sources 3Y, 3M and 3C for the colors other than black are not adjusted, the position of the light source 3B for black may be firstly adjusted.

Since the light sources and all the components of the pre-deflection optical systems are mounted on the subplate SA, the optical axes and the focal points are roughly adjusted in the state that the subplate SA is not mounted on the unit. The adjustment is made while using a position sensor or the like which converts a light receiving position into an electric signal.

Thereafter, the subplate SA is mounted on the unit, the optical deflecting device 7 is attached to the unit, and the angle of the polygon motor 7b is adjusted by using the advancing and retreating movements of the shim SB (therefore, the angle of the reflecting surface of the polygon mirror 7a attached to the rotational axis of the polygon motor is adjusted).

In comparison with the case where the optical axes including the optical deflecting device 7 in the unit are adjusted at one time, the adjustment including the two steps like the first embodiment can further improve the optical properties and a shift amount of the optical paths.

### (C) Second Embodiment

The optical beam scanning device, the image forming apparatus, and the method of adjusting the optical beam scanning device according to a second embodiment of the present invention are explained below.

Since the color image forming apparatus using the optical beam scanning device according to the second embodiment can be constituted as shown in FIG. 13 in the first embodiment, the explanation thereof is omitted.

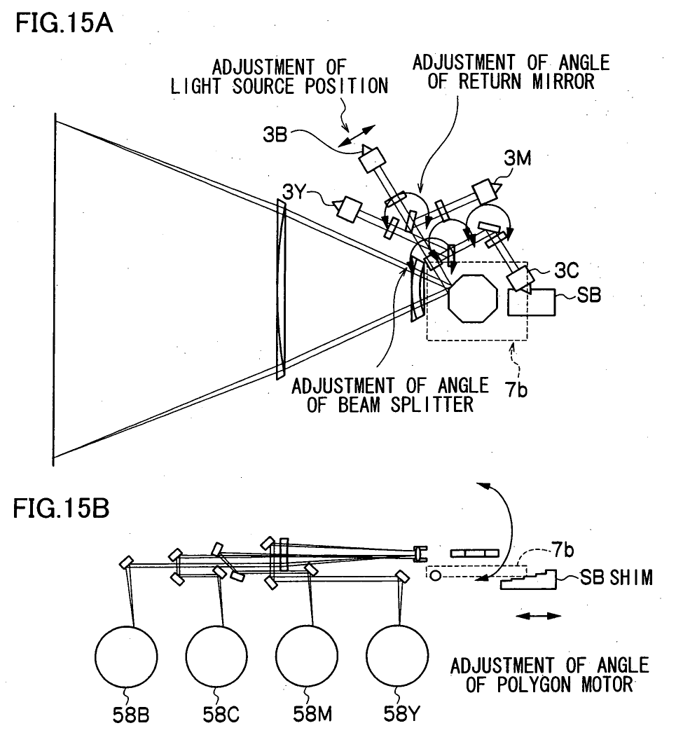

FIGS. 15A and 15B area schematic plan view and a schematic sectional view illustrating the multi-beam optical scanning device 1 according to the second embodiment to be incorporated into the image forming apparatus shown in FIG. 13, and correspond to FIGS. 14A and 14B in the first embodiment. FIGS. 15A and 15B clearly illustrate the constitution which can realize the second adjusting method.

The optical beam scanning device 1 according to the second embodiment has the same components of the optical system as those in the first embodiment, and thus the explanation thereof is omitted. The method of adjusting the optical beam scanning device 1 according to the second embodiment is according to the second adjusting method.

The optical beam scanning device 1 according to the second embodiment does not have the subunit (subplate), and the components of the pre-deflection optical system are attached directly to the unit. The unit is provided with the adjusting mechanisms of the pre-deflection optical systems (the adjusting mechanisms are similar to those in the first embodiment), so that the optical axes (polarization beam splitter 19, the return mirrors 15Y, 15M and 15C, and the positions of the light sources 3Y, 3M, 3C and 3B and the like) can be adjusted.

In the second embodiment, a housing of the unit has a hole for guiding the light beams to the outside of the unit in the state that the optical deflecting device 7 is detached, and while the positions of the light beams emitted from the hole are being measured by the position sensor or the like, the optical axes are adjusted.

Thereafter, the optical deflecting device 7 is attached and the angle is adjusted. The angle adjusting mechanism for the optical deflecting device 7 can utilize the advancing and retreating movements of the step-shaped shim SB similarly to the first embodiment.

In comparison with the case where the optical axes in the unit including the optical deflecting device 7 are adjusted at one time, the adjustment including the two steps can further improve the optical properties and a shift amount of the optical paths in the second embodiment.

### (D) Third Embodiment

The optical beam scanning device, the color image forming apparatus and the method of adjusting the optical beam scanning device according to a third embodiment of the present invention are explained below.

Since the color image forming apparatus using the optical beam scanning device according to the third embodiment can be also constituted as shown in FIG. 13 of the first embodiment, the explanation thereof is omitted.

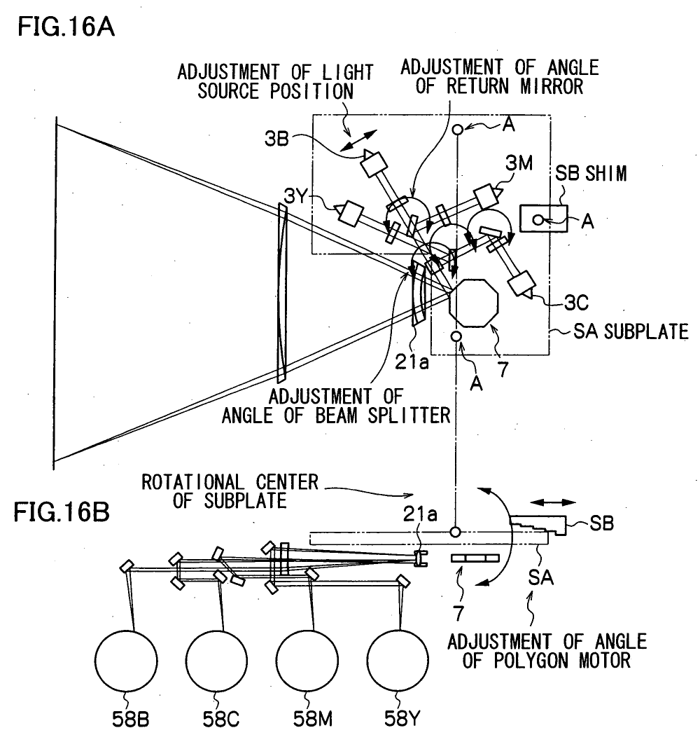

FIGS. 16A and 16B are a schematic plan view and a schematic sectional view illustrating the multi-beam optical scanning device 1 according to the third embodiment to be incorporated into the image forming apparatus shown in FIG. 13, and correspond to the FIGS. 14A and 14B in the first embodiment. FIGS. 16A and 16B clearly illustrate the constitution which can realize the third adjusting method.

The optical beam scanning device 1 according to the third embodiment has the same components of the optical system as those in the first embodiment, and the explanation thereof is omitted. The method of adjusting the optical beam scanning device 1 according to the third embodiment is according to the third adjusting method.

In the optical beam scanning device 1 according to the third embodiment, as shown in FIGS. 16A and 16B, the optical deflecting device 7 (polygon motor 7b) as well as the pre-deflection optical system 5 can be also mounted on the subplate (subunit) SA.

The optical axes of the pre-deflection optical systems are adjusted in the state that the optical deflecting device 7 (polygon motor 7b) is detached. Since the subplate SA is used, the optical axes of the pre-deflection optical systems (the polarization beam splitter 19, the return mirrors 15Y, 15M and 15C, and the positions of the light sources 3Y, 3M, 3C and 3B and the like) can be adjusted similarly to the first embodiment.

Thereafter, the optical deflecting device 7 (polygon motor 7b) is mounted on the subplate SA integrally, and the subplate SA is mounted on the unit. The angle of the subplate SA is adjusted, so that the angle of the polygon motor 7b (therefore, the angle of the reflecting surface of the polygon mirror 7a) is adjusted.

The angle adjusting mechanism for the subplate SA on which the optical deflecting device 7 (polygon motor 7b) is mounted can utilize the advancing and retreating movements of the step-shaped shim SB. A rotational center of the subplate SA in this case is a position parallel with the main scanning direction in the deflected laser beams from the optical deflecting device 7, and is provided to a position close to the effective reflecting surface of the optical deflecting device 7.

In comparison with the case where the optical axes including the optical deflecting device 7 in the unit are adjusted at one time, since the adjustment including the two steps can be made in the third embodiment, the optical properties and a shift amount of the optical paths can be improved.

### (E) Fourth Embodiment

The optical beam scanning device, the image forming apparatus and the method of adjusting the optical beam scanning device according to a fourth embodiment of the present invention are explained below.

Since the color image forming apparatus using the optical beam scanning device according to the fourth embodiment can be also constituted as shown in FIG. 13 of the first embodiment, the explanation thereof is omitted.

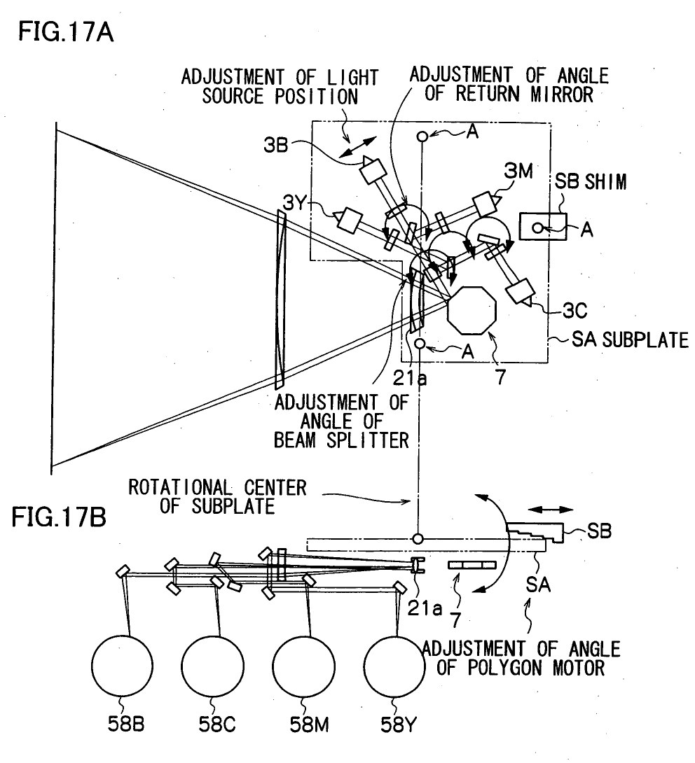

FIGS. 17A and 17B are a schematic plan view and a schematic sectional view illustrating the multi-beam optical scanning device 1 according to a fourth embodiment to be incorporated into the image forming apparatus shown in FIG. 13, and correspond to FIGS. 14A and 14B in the first embodiment. FIGS. 17A and 17B clearly illustrate the constitution which can realize the fourth adjusting method.

The optical beam scanning device 1 according to the fourth embodiment also has the same components of the optical system as those in the first embodiment, and explanation thereof is omitted. The adjusting method for the optical beam scanning device 1 according to the fourth embodiment is according to the fourth adjusting method.

The optical beam scanning device 1 according to the fourth embodiment is a mechanism where, as shown in FIGS. 17A and 17B, the optical deflecting device 7 (polygon motor 7b) and the first fθ lens 21a as well as the pre-deflection optical system 5 can be fixed to the subplate (subunit) SA integrally.

The optical deflecting device 7 (polygon motor 7b) and the first fθ lens 21a are detached from the subplate SA, and the optical axes of the pre-deflection optical systems 5 are adjusted. Since the subplate SA is used, the optical axes of the pre-deflection optical systems (the polarization beam splitter 19, the return mirrors 15Y, 15M and 15C, the positions of the light sources 3Y, 3M, 3C and 3B, and the like) can be adjusted similarly to the first embodiment.

Thereafter, the optical deflecting device 7 (polygon motor 7b) and the first fθ lens 21a are mounted on the subplate SA integrally, and the subplate SA is placed on the unit. The angle of the subplate SA is adjusted so that the angle of the polygon motor 7b (therefore, the angle of the reflecting surface of the polygon mirror 7a) is adjusted.

The mechanism that adjusts the angle of the subplate SA mounted with the optical deflecting device 7 (polygon motor 7b) and the first fθ lens 21a can utilize the advancing and retreating movements of the step-shaped shim SB, for example. The rotational center of the subplate SA according to the fourth embodiment is provided to the position which is parallel with the main scanning direction in the deflected laser beams from the optical deflecting device 7 and is close to the effective reflecting surface of the optical deflecting device 7.

In comparison with the case where the optical axes including the optical deflecting device 7 are adjusted at one time in the unit, the adjustment including the two steps can be made in the fourth embodiment, thereby improving the optical properties and a shift amount of the optical paths.

### (F) Another Embodiment

The explanation of the above embodiments refers to various modified embodiments, but the following modified embodiment can be provided.

Differently from FIGS. 16A to 17B, a member that regulates the rotational center of the subplate may be a projected rim or the like which is linearly in contact with the subplate.

A main characteristic of the present invention is that the mechanism that adjusts the angle of a deflector (polygon mirror) is provided separately from the optical axis adjusting mechanism for the pre-deflection optical system, and the present invention can be applied not only to the multi-beam optical scanning device but also to a single beam optical scanning device.

The above embodiments explain the multi-beam optical scanning device that uses only one reflecting surface of the deflector (polygon mirror), but the present invention can be applied also to a multi-beam optical scanning device that uses two reflecting surfaces of the deflector (polygon mirror) Further, the present invention can be applied also to a multi-beam optical scanning device that is provided with two polygon mirrors on the rotational axis of the polygon motor and uses two reflecting surfaces of each polygon mirror.

What is claimed is:

1. An optical beam scanning device, comprising:
a single optical deflecting device;
a pre-deflection optical system that allows a light beam from a light source to enter the optical deflecting device;
a post-deflection optical system that images a reflected light beam from the optical deflecting device on a surface to be scanned;
an optical axis adjusting mechanism that adjusts an optical axis of the pre-deflection optical system; and
an optical deflecting device angle adjusting mechanism that adjusts the angle of the optical deflecting device separately from the optical axis adjusting mechanism of the pre-deflection optical system.

2. The optical beam scanning device according to claim 1, wherein the pre-deflection optical system is mounted on one subunit, the subunit is mounted on a unit of the optical beam scanning device, and the subunit has the optical axis adjusting mechanism.

3. The optical beam scanning device according to claim 1, wherein
components of the pre-deflection optical system and the optical deflecting device are arranged on the unit of the optical beam scanning device,
the optical axis adjusting mechanism can adjust the optical axis in a state that the optical deflecting device is not mounted.

4. The optical beam scanning device according to claim 3, wherein the unit of the optical beam scanning device has an optical window that guides the light beam emitted from the pre-deflection optical system to an outside of the unit in the state that the optical deflecting device is not mounted.

5. The optical beam scanning device according to claim 1, wherein
at least the pre-deflection optical system and the optical deflecting device are mounted on one subunit, and the subunit is mounted on a unit of the optical beam scanning device,
the optical axis adjusting mechanism is provided onto the subunit,
the optical deflecting device angle adjusting mechanism is a mechanism that rotationally moves the subunit.

6. The optical beam scanning device according to claim 5, wherein the subunit is mounted also with an optical element on the closest side to the optical deflecting device in one or a plurality of optical elements in the post-deflection optical system that images the light on the surface to be scanned.

7. The optical beam scanning device according to claim 1, wherein the pre-deflection optical system has a plurality of light sources, and the optical deflecting device deflects the light beams from the light sources.

8. The optical beam scanning device according to claim 7, wherein the pre-deflection optical system has an optical path synthesizing element that synthesizes optical paths of the light beams, and the optical axis adjusting mechanism includes an adjusting mechanism for an angle of the optical path synthesizing element in a main scanning direction.

9. The optical beam scanning device according to claim 7, wherein the pre-deflection optical system has a return mirror, and the optical axis adjusting mechanism has an angle adjusting mechanism for the return mirror.

10. The optical beam scanning device according to claim 7, wherein the light beams except for one light beam have a mechanism element of the optical axis adjusting mechanism on their optical paths.

11. An optical beam scanning device adjusting method, wherein
an optical beam scanning device to be adjusted includes a single optical deflecting device, a pre-deflection optical system that allows a light beam from a light source to enter the optical deflecting device, a post-deflection optical system that images a reflected light beam from the optical deflecting device on a surface to be scanned, an optical axis adjusting mechanism that adjusts an optical axis of the pre-deflection optical system, and an optical deflecting device angle adjusting mechanism that adjusts the angle of the optical deflecting device separately from the optical axis adjusting mechanism of the pre-deflection optical system,
the optical axis adjusting mechanism is used to adjust the optical axis in the pre-deflection optical system,
the optical deflecting device angle adjusting mechanism is used to adjust the angle of the optical deflecting device.

12. An image forming apparatus, comprising:
an optical beam scanning device including a single optical deflecting device, a pre-deflection optical system that allows a light beam from a light source to enter the optical deflecting device, a post-deflection optical system that images a reflected light beam from the optical deflecting device on a surface to be scanned, an optical axis adjusting mechanism that adjusts an optical axis of the pre-deflection optical system, and an optical deflecting device angle adjusting mechanism that adjusts the angle of the optical deflecting device separately from the optical axis adjusting mechanism of the pre-deflection optical system, and
a photoconductor that has a surface to be scanned on which a latent image is formed based on the light beam from the optical beam scanning device.
